(19) United States
(12) Patent Application Publication
(10) Pub. No.: US 2022/0032506 A1
(43) Pub. Date: Feb. 3, 2022

(54) MANUFACTURING METHOD TO CAST PARTS WITH ADDITIVE MANUFACTURING GEOMETRY COMPLEXITY

(71) Applicant: Andrey Salfetnikov, Vancouver, WA (US)

(72) Inventor: Andrey Salfetnikov, Vancouver, WA (US)

(21) Appl. No.: 16/941,440

(22) Filed: Jul. 28, 2020

(51) Int. Cl. B29C 33/38; B33Y 10/00; B33Y 80/00; B29C 64/393; B29C 64/112; B33Y 50/02; B29C 45/26; B22C 9/08; B22C 7/02

(52) U.S. Cl. CPC B29C 33/3842; B33Y 10/00; B33Y 80/00; B29C 64/393; B29L 2031/757; B33Y 50/02; B29C 45/26; B22C 9/08; B22C 7/02; B29C 64/112

(57) ABSTRACT

Molds are produced by additive manufacturing and define parts cavities with part infills that can be ribbed or cellular. The molds are processed to sequentially remove infills to open part cavities to which part materials are introduced. Embedded or captured parts can be molded, and thermal channels can be provided to thermally isolate different materials.

### FIELD

The disclosure pertains to molding processes using additive manufacturing.

### BACKGROUND

Molding methods typically require precise machining of a master mold for use in production. While the molding process itself can be rapid and inexpensive, fabricating the master mold can be expensive and time-consuming. In many cases, even minor changes to molding surfaces necessitate fabrication of a new mold. In addition, complex geometries can be difficult or impossible to mold. In view of the above and other problems with conventional molding approaches, alternative molds and molding processes are needed.

### SUMMARY

Methods comprise selecting at least a mold material and a sacrificial material and with an additive process, and defining, layer-by-layer, (1) at least a portion of a mold with the mold material, wherein the mold includes at least one mold port, and (2) defining at least a portion of a part cavity with the sacrificial material. In some examples, at least one fill port is defined with the sacrificial material, wherein the fill port is coupled to the part cavity. In other example, the defining at least the portion of the mold with the mold material includes defining at least a portion of a part outline in the mold material or defining at the least the portion of the part cavity with the sacrificial material or both. In typical examples, the portion of the mold defined with the mold material includes a mold infill. According to some embodiments, the mold infill defined with the mold material includes one or more of a ribbed mold infill and a cellular mold infill. In some examples, either the portion of the part cavity defined with the sacrificial material includes a part infill or portion of the sacrificial material defines a sacrificial material infill that is a cellular or ribbed infill. In further examples, the fill ports contain the sacrificial material, and methods further comprise removing the sacrificial material from the part cavity and the fill ports. In still other examples, the sacrificial material is removed from the part cavity with the fill ports. According to representative examples, the part cavity is filled with a part material and processed to produce the part and the part is separated from the mold. In some embodiments, the part is separated from the mold by one or more of injecting a solvent for the mold material into at least one of the mold ports, placing the mold into a liquid solvent, exposing the mold to a gas solvent, and placing the mold in a temperature chamber and melting the mold material. In further examples, the selecting the sacrificial material includes selecting a first sacrificial material and a second sacrificial material, the first and second sacrificial materials being independently sacrificial. Defining at least the portion of the part cavity with the sacrificial material includes defining a first part cavity with the first sacrificial material and a second part cavity with the second sacrificial material, wherein the first part cavity and the second part cavity are adjacent so that the second part cavity is bounded in part by the first sacrificial material in the first part cavity. In other examples, at least one fill port is coupled to the first part cavity with the first sacrificial material and at least one fill port is coupled to the second part cavity with the second sacrificial material. In typical examples, infill structures are defined in at least one of the mold, the first part cavity, and the second part cavity with the mold material, the first sacrificial material, and the second sacrificial material, respectively.

In some examples, the first sacrificial material is removed from the first part cavity and the first part cavity is filled with a first part material with the fill ports defined in the first sacrificial material. The first part material is processed to produce a first part. According to some implementations, the second sacrificial material is removed from the second part cavity and the second part cavity is filled with a second part material with the fill ports, and the second part material is processed to produce a second part. In particular implementations, the first part cavity is bounded by the second sacrificial material in the second part cavity and at least one fill port is coupled to the first part cavity and extends through the second part cavity.

In some examples, the selecting the sacrificial material includes selecting first, second, and third sacrificial materials, wherein at least the first and second sacrificial materials are independently sacrificial. The defining at least the portion of the part cavity with the sacrificial material includes defining a first part cavity with the first sacrificial material, a second part cavity with the second sacrificial material, and a third part cavity with the third sacrificial material, wherein the first part cavity is enclosed by the second part cavity, and the second part cavity is enclosed by the third part cavity, and the third part cavity is enclosed by the mold material, wherein the first and third sacrificial materials are the same or different. In some cases, fill ports coupled to the first, second, and third part cavities are defined, wherein the respective fill ports extend through the second part cavity, the third part cavity, and the mold material. In further examples, the first, second, and third sacrificial materials are sequentially removed and each of the first, second, and third parts cavities is filled with respective part materials to form first, seconds, and third part.

Molds comprise a plurality of layers, wherein one or more layers contains at least one mold material and at least one sacrificial material, the sacrificial material forming a part infill corresponding to a part cavity. In some examples, molds further comprise at least one port coupled to the sacrificial material and defining a port infill formed with the sacrificial material. In some examples, the at least one sacrificial material includes first and second independent sacrificial materials, and the first and second independent sacrificial materials define respective part infills corresponding to respective part cavities. In some embodiments, the first part infill and the second part infill are in contact. According to a representative example, the first part infill is situated below the second part infill, and a port is coupled to the first part infill through the second part infill and formed with the first sacrificial material. In further examples, the at least one sacrificial material includes first, second, and third independent sacrificial materials defining respective first, second, and third part infills corresponding to respective part cavities. In some embodiments, a port is coupled to the first part infill through the second part infill and the third part infill, the port comprising layers of the first, second, and third sacrificial materials. In some implementations, a thermal channel infill is situated about the part infill. In some alternatives, the at least one sacrificial material forms part infills corresponding to a first part cavity and a second part cavity that define first and second parts, respectively, wherein the first part is a captive part with respect to the second part. In representative examples, an infill is situated between the first part cavity and the second part cavity so that the first part is movably captured by the second part in the absence of the infill.

The foregoing and other objects, features, and advantages will become more apparent from the following detailed description, which proceeds with reference to the accompanying figures.

### BRIEF DESCRIPTION OF THE DRAWINGS

FIG. 1A illustrates a representative system for producing molds using additive manufacturing.

FIG. 1B illustrates a representative system for molding parts according to the disclosed methods.

FIGS. 2A-2B are sectional plan views that illustrate a representative mold according to the disclosure.

FIG. 2C is a sectional perspective view of a portion of the mold shown in FIGS. 2A-2B.

FIG. 3A illustrates a representative method of molding a part.

FIG. 3B illustrates a representative method of molding a part.

FIGS. 4A-4F illustrate representative molds and associated mold and part infills.

FIGS. 5A-5B illustrate a portion of a representative mold that includes ports defined by one or more layers of sacrificial materials.

FIGS. 6A-6B illustrate molding of an encapsulated part.

FIG. 7 illustrates a mold that defines adjacent parts in which part cavities and/or parts serve as portions of a mold for other parts.

FIGS. 8A-8B illustrate additional representative arrangements of part infills and port infills.

FIGS. 9A-9C are a plan sectional view and perspective sectional views illustrating a mold that contains channels for temperature control.

FIGS. 10A-10B are a plan sectional view and a perspective sectional view illustrating a mold that contains a cavity in which a thermal barrier can be formed.

FIGS. 10C-10D are sectional views of a mold illustrating production of a temperature reduction or temperature control wall using a casting process.

FIGS. 11A-11AA illustrate a captive part to be molded using an additive mold.

FIGS. 11B-11F illustrate molding captive parts using one or more coatings.

FIGS. 12A-12B illustrate molding captive parts using a spacer layer defined in a mold infill.

FIG. 13 illustrates molding captive parts using a sacrificial spacer layer.

### DETAILED DESCRIPTION

The disclosure pertains to additive manufacturing methods and apparatus that can permit molding of parts having complex geometries. Additive manufacturing can be used to produce multi-material, single-use molds for simple or complex geometries. Molds made using an additive approach can be complex and a master model is not needed, and in general, the disclosed molds need not be re-useable. Part shrinking, warping, and shrinkage due to solidifying/curing can be controlled, reduced, or minimized using mold designs that can provides constant rates or otherwise controlled rates of cooling/heating. Portions of an additive mold can be used to create one or more cavities that can define final parts by filling the cavity with suitable materials and solidified by, for example, curing. Parts can be removed by dissolving, melting or otherwise removing mold portions from the part, so that damage or deformation due to mechanical stress used to remove the part from mold can be reduced since the mold can be gently separated from the part by dissolving/melting the remaining mold material.

For purposes of the following description, additive manufacturing or 3D printing refers to layer-by-layer formation of a mold that defines part cavities. For convenience, cavities and mold surfaces that are defined at least in part by a layer are referred to as in-layer bounded while surfaces defined between layers are referred to as between-layer bounded. In the examples, layers are formed in planes parallel to an xy-plane of a three dimensional Cartesian coordinate system and in-layer bounded surfaces extend in the xy-plane. Layers are built up in a z-axis direction. In some cases, layers are referred to as being above or below other layers in that they are displaced along a z-axis direction, but without implying any particular spatial orientation otherwise. Typically, at least hundreds or thousands of layers are printed, with layers having the same or different thicknesses, frequently in range from about 2 μm to about 500 μm.

As used herein, sacrificial materials refer to materials that are removable to define part cavities that are fillable with a part material that forms a part to be produced with molding with the part cavity. Such sacrificial materials are removable with solvents, heat, pressure or otherwise removable. Mold materials are materials used to define part cavities and can be removable with solvents, heat, pressure or otherwise removable as well. In some examples, portions of sacrificial materials also define at least portions of a part cavity. For example, a second part cavity adjacent a first part cavity and a mold surface can define at least a portion of the first part cavity. After the first part cavity is used to define a first part, the sacrificial material in the second part cavity can be removed, and a second part defined using the mold and the first part. A first sacrificial material that can be removed without removal of a second sacrificial material is referred to herein as “independent.” Typically, different solvents or different processes are used with independent sacrificial materials. For example, a first material can be removed with temperature or pressure, and a second removed with a solvent. In other examples, different solvents are used for each.

As used herein, “port” refers to a portion of a mold that provides access to a part cavity or a section of a mold, generally to permit filling or evacuating a cavity or mold section. Regions of a mold that are targeted for use in defining parts are referred to as part cavities although at some process steps, such cavities are filled or partially filled with materials, typically referred to as infills or part infills. Mold portions are typically defined by mold infills. For example, a mold can define a part cavity by printing a suitable cavity infill that fills the volume associated with the part cavity. This infill can be removed to open up the cavity.

### Example 1. Representative Additive Molding System

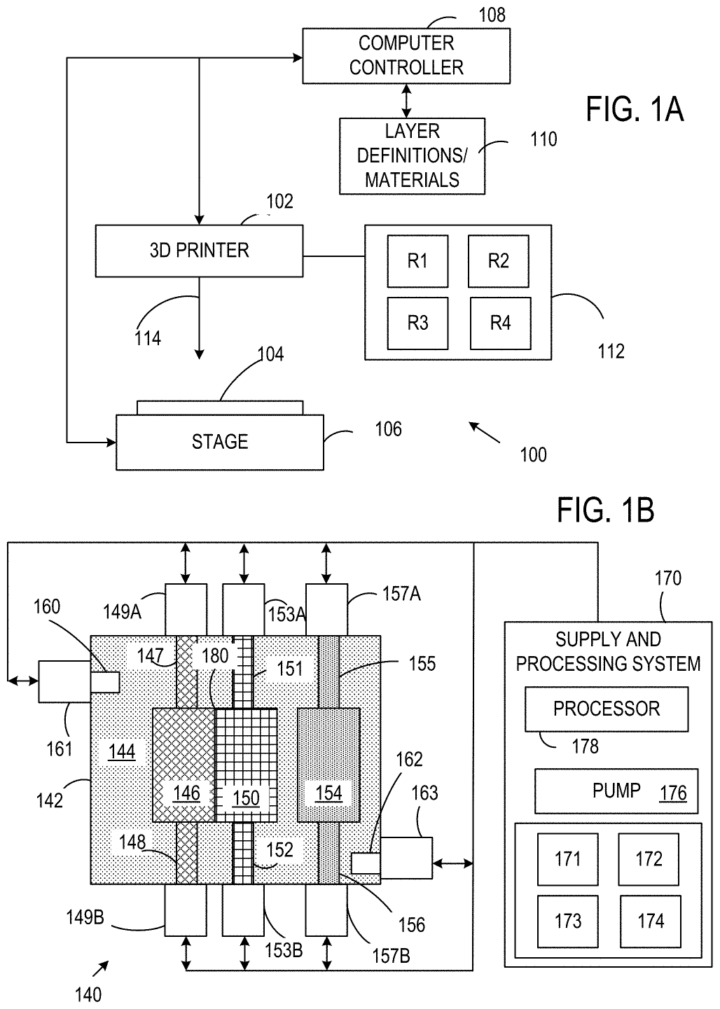

Referring to FIG. 1A, a representative system 100 for molding parts includes a 3D printer 102 that is situated to deposit materials such as mold materials and sacrificial materials on a substrate 104 that is movable with a stage 106. In some cases, the 3D printer 102 or one or more print heads are movable in addition to or instead of the substrate 104. The 3D printer 102 and the stage 106 are coupled to a computer controller 108 that is coupled to a memory 110 that stores mold patterns for multiple layers, material information, and computer-executable instructions that control printing of materials. The 3D printer 102 is coupled to a set 112 of material reservoirs that includes reservoirs R1-R4 that can contain the same or different materials. In other examples, fewer or more reservoirs are used which can use the same or different materials.

### Example 2. Representative System Using an Additive Mold

Referring to FIG. 1B, a representative manufacturing system 140 includes a mold 142 in which a mold material 144 defines parts cavities 146, 150, 154 that are shown as filled with different sacrificial materials. The part cavity 146 is coupled by ports 147, 148 to reservoirs 149A, 149b that are situated to inject solvents, gases, mold materials, or sacrificial materials. For example, the couplers 149A, 149B can supply solvents for removing sacrificial material to open the part cavity 146 or to supply part materials for part molding. The part cavity 150 is coupled by ports 151, 152 to reservoirs 153A, 153B that are situated to inject solvents, gases, mold materials, or sacrificial materials. Similarly, the part cavity 154 is coupled by ports 155, 156 to couplers 157A, 157B that are situated to inject solvents, gases, mold materials, or sacrificial materials. Ports 160, 162 are coupled to respective couplers 161, 163 to access the mold material 144 with, for example, solvents or gases to remove material, supply additional materials, evacuate or purge a cavity, or temperature control the part cavity. A supply system 170 includes reservoirs 171-174 and one or more pumps such as representative pump 176 as well as a processor controller 178 that controls pumps and valves (not shown) to control and supply materials to the various ports. In some cases, a pump is coupled to provide a vacuum to evacuate a cavity or a portion of a mold. In the example of FIG. 1B, the part cavities 146, 150 have a common wall 180 so that the parts can serve as portions of a mold. Fewer or more reservoirs can be used, and the mold 142 can be situated in a chamber that is evacuated or filled with a particular gas mixture. Lines to the supply system 170 can go through the chamber wall and ambient pressure around the mold, pressure inside the mold, and pressure in part cavities can all be controlled independently as needed.

### Example 3. Representative Additive Mold

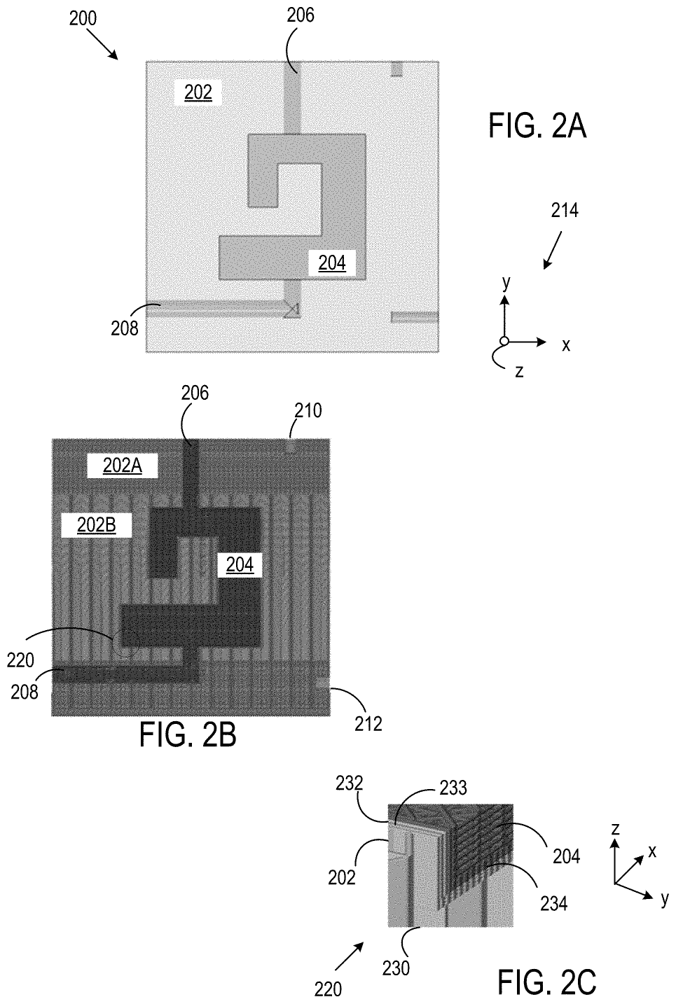

A single layer of a mold 200 in an xy-plane of a coordinate system 214 is shown in FIGS. 2A-2B and a perspective sectional view is shown in FIG. 2C. The mold 200 includes a part cavity 204 and solvent ports 206, 208 coupled to the part cavity 204 as defined by a mold material 202. Mold ports 210, 212 are coupled to the volume that is provided with the mold material 202. The mold material is deposited as patterned areas (“infill”) 202A, 202B as shown in FIG. 2B. The filled part cavity 204 is also patterned as shown in FIG. 2B. Patterning is generally provided for mold strength and to permit suitable inflow and outflow of gases and solvents in use. A portion 220 of the mold 200 as viewed in multiple layers is shown in FIG. 2C. The part cavity 204 interfaces with the mold material 202 at a boundary 234. The mold material 202 and the filled part cavity 204 are configured to have respective boundaries 232, 234 that can provide superior strength and edge definition in molding.

The mold 200 can be made with additive manufacturing and can be used to manufacture a part as follows. The solvent ports 206, 208 are coupled to permit one or more solvents to access the part cavity 204 to remove part infill materials and open up the part cavity 204. The mold material/part cavity boundary can be post-processed via the solvent ports 206, 208. Part material can be introduced into the part cavity 204 via the solvent port 206, 208 and the mold ports used to introduce a gas or liquid into the infill 202A, 202B to control heating or cooling of the part material. In typical examples, the mold material is used to define a boundary region 233 with the part cavity 204 to provide suitable strength.

### Example 4. Representative Molding Methods

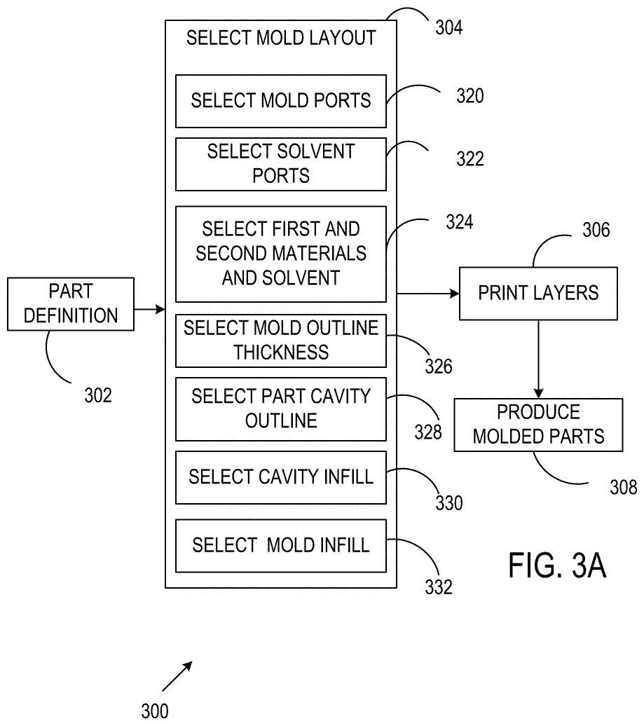

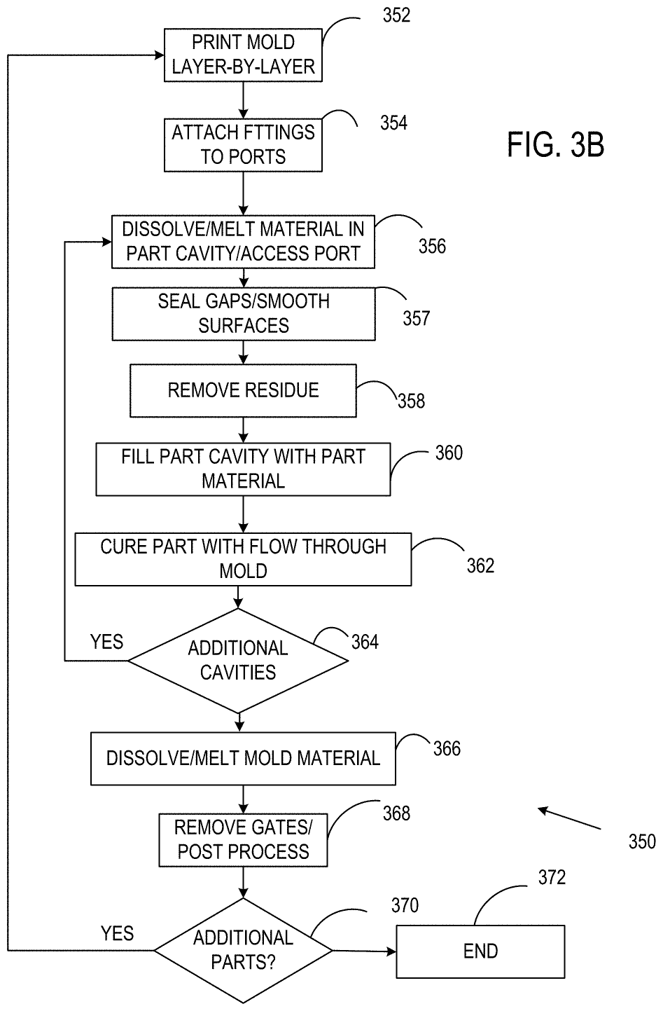

Referring to FIG. 3A, a representative method 300 of molding a part includes obtaining a part definition as 302 based on part size, shape, mechanical and other properties. At 304 a mold layout is selected, and at 306, the layers of the mold are printed. At 308, molded parts are produced with the printed mold. Selection of a mold layout typically involves selecting mold ports at 320, selecting solvent ports at 322, selecting materials for the mold and the part (and sacrificial materials) at 324. As noted above, one, two, three, or more sacrificial materials can be used. At 326, a mold outline thickness is selected which can vary at different portions of the mold, and a part cavity outline is selected at 328. Cavity and mold infill and patterns are selected at 330, 332, respectively. The mold layout steps 320-332 can generally be performed in any order, and the arrangement shown in FIG. 3A is only a representative example.

FIG. 3B illustrates a representative method 350 for part fabrication using the disclosed molds. At 352, a mold is printed layer-by-layer, and at 354, fittings are attached to one or more ports, typically as least solvent ports as mold ports are not yet needed. At 356, a solvent is used to dissolve, melt, or otherwise remove any material in the part cavity. Solvent temperature, pressure, and flow rate can be selected and fluid motion can be used with ultrasonic vibration or moving or oscillating the mold, and directions of oscillation and ultrasonic vibration can be varied and can be randomly varying, If desired, air gaps can be sealed and mold surfaces that contact part materials can be smoothed at 357. In some cases it is desirable to seal air gaps that may exist between individual layers and/or smooth the mold boundary surface. For example, parts are often not water tight when using fused deposition modeling (FDM) 3D printing technology and sometimes it is desirable to create a water tight boundary at the surfaces that define the part cavity. It may also be desirable to decrease the visibility of layer lines for a smooth surface. A gas or liquid can be used for selected times, pressures, flow rates, and temperatures. At 358, any residue is removed using a different solvent or using a higher temperature, blowing a dry gas into the part cavity, or evacuating the part cavity to form a vacuum. Evacuating the mold or injecting gas or liquid into the mold can be also use to prevent deformation. In some cases, the mold is brought to a selected temperature and vacuum is applied to the part cavity. At 360, the part cavity is filled with part material via the solvent ports, and vibration or evacuation can be used, if desired. At 362, the part material is cured and/or treated. In some examples, flow through or pressure in other portions of the mold are used for temperature control or to provide mold strength. At 366, the mold material is removed by, for example, dissolving or melting, and at 368, gates are removed and the molded part post-processed as needed. If additional parts are to be molded as determined at 370, processing returns to 352 for printing of an additional mold. Alternatively, if additional cavities are to be used as determined at 364, the method returns to 356 to remove additional cavity materials. Otherwise, at 372, processing terminates. In some cases, a mold or portions thereof can be reused, but typically only a single part is made from each mold.

### Example 5. Representative Part, Mold, and Port Infills

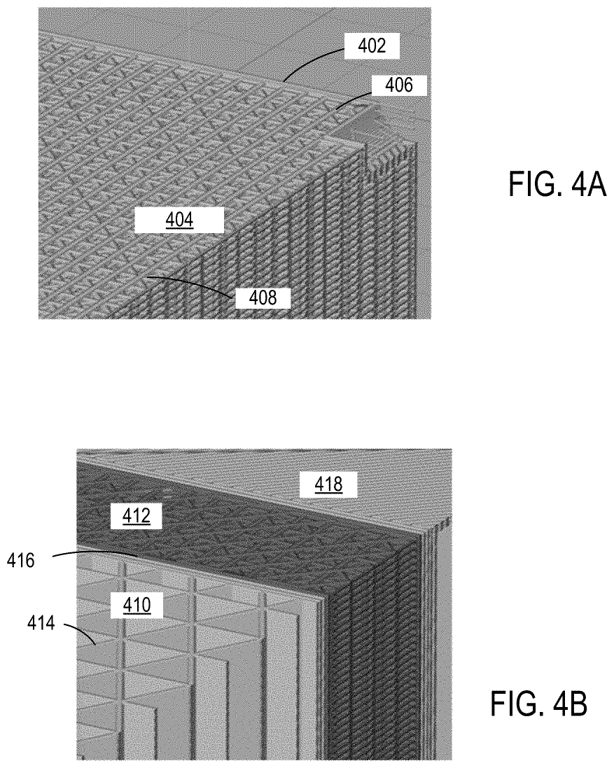

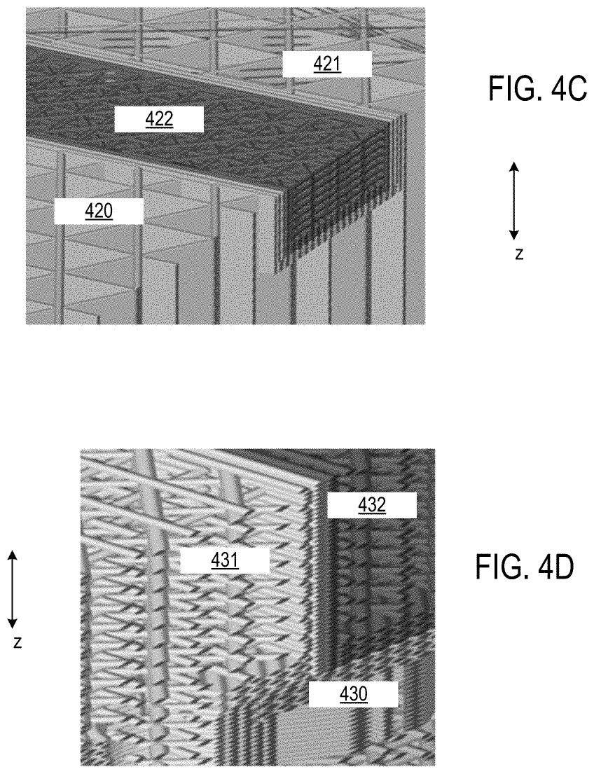

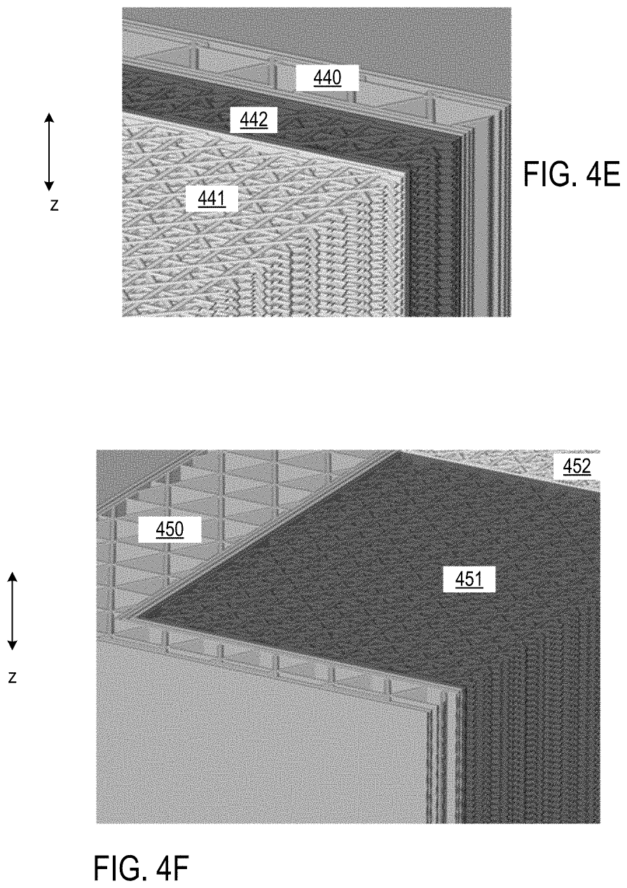

FIGS. 4A-4F illustrate various types of infill. FIG. 4A illustrates a mold 402 that includes an infill volume 404 that includes linear ribs at various angles such as representative ribs 406, 408 that are at an angle of 45 degrees. Ribs are typically at different angles in adjacent layers. This infill can be referred to as variable angle infill, and often alternates rib angles layer-to-layer, with two rib angles used in each layer, but other arrangements can be used. The rectilinear infill of FIG. 4A is conveniently used above and below part cavities. Such rectilinear infills are also referred to as ribbed infills.

FIG. 4B illustrates honeycomb or triangular infill 410 that is provided in a layer that also define a part cavity 412. The triangular/honeycomb infill 410 is defined by a plurality of cells such as cell 414 that extends through multiple layers and has a cross-section that is triangular, rectangular, other shape. The infill 410 terminates at the part cavity 412. In this example, the part cavity 412 is defined with rectilinear infill as shown in FIG. 4B and is bounded by infill 418 that can be rectilinear, honeycomb, or other pattern or patterns. The infill 410 can be referred as cellular infill because in includes open cells that extend through multiple layers. FIG. 4C illustrates a ribbed infill 422 situated between cellular infills 420, 421. In this example, portions of the cellular infills 420, 421 can be situated below the ribbed infill 422.

In the above examples, a first material (a mold material) is used to define infill for the mold portion and a second material (a sacrificial material) defines the part cavity. In other examples, three or more materials are used. Referring to FIG. 4D, infills 430, 431, 432 (cellular and ribbed) are used for a mold region and two part cavities. In an example shown in FIG. 4E, part cavities are defined by rectilinear infills 441, 442 and a mold boundary by a cellular (rectangular) infill 440 that are typically formed of different materials so that, for example, the infill 442 can be removed while a boundary defined by the infill 441 remains for molding a part using the part cavity defined by the infill 440 which can be removed last. In a further example shown in FIG. 4F, part cavities are defined by rectilinear infills 451, 452 and are bounded by a cellular (rectangular) infill 450 and are typically formed of different (independent) materials so that, for example, the infill 451 can be removed while the infill 452 remains for molding a part using the part cavity defined by the infill 450 and a boundary defined by the infill 452.

### Example 6. Representative Layered Ports

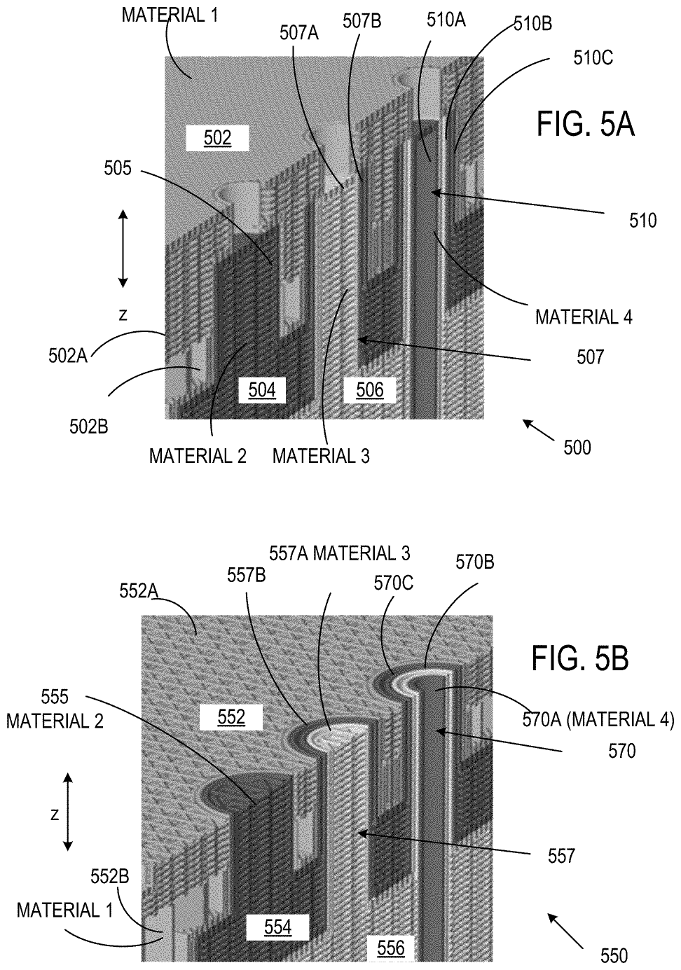

FIGS. 5A-5B illustrate infills used to define various ports for a printed mold. For convenience, these figures are described with reference to materials 1-4, wherein materials 2-4 define part cavities and are sacrificial materials, and material 1 is used as mold material. Each of these can be selectively removed with solvents or temperature and can all be different. Other configurations are possible as well.

Referring to FIG. 5A, a portion 500 of a mold includes a mold infill 502 and part infills 504, 506 in which ports 505, 507, 510 are defined. The mold infill 502 is made of a material 1 and includes a ribbed portion 502A and a cellular portion 502B. A material 4 is used to define a central portion 510A of the port 510 and part infills for one or more part cavities (not shown) that can be coupled to by removing material 4 from the port 510. The central portion 510A defines a tube that extends through the infill 504 and the infill 506. A material 3 is used to define a central portion 507A of the port 507, an intermediate portion 510B of the port 510, and the part infill 506. A material 2 is used to define the port 505, a perimeter portion 507B of the port 507, a perimeter portion 510C of the port 510, and the part infill 504.

Referring to FIG. 5B, a portion 550 of a mold includes a mold infill 552 and part infills 554, 556 in which ports 555, 557, 570 are defined. The infill 552 includes a ribbed portion 552A and a cellular portion 552B made of a material 1. A material 4 is used to define a central portion 570A of the port 570 and part infills for one or more part cavities (not shown) that can be coupled to by removing material 4 from the port 570. The central portion 570A defines a tube that extends through the infill 554 and the infill 556. A material 3 is used to define a central portion 557A of the port 557, an intermediate portion 570B of the port 570, and the part infill 556. A material 2 is used to define the port 555, a perimeter portion 557B of the port 557, a perimeter portion 570C of the port 570, and the part infill 554.

The configurations of FIG. 5A-5B permit molding of complex, multilayer parts. Referring to FIG. 5B, for example, the mold portion 550 permits removal of the central portion 570A of the port 570 (i.e., material 4) so that part infills in communication with the port 570 and having a common sacrificial material (material 4) can be removed. After parts are formed using these part cavities, the central portion 557A of the port 557, the intermediate portion 570B of the port 570, and the part infill 556 (i.e., material 3) can be removed to access and define one or more part cavities, such as a part cavity corresponding to the part infill 556. Parts are formed using such part cavities. Then the perimeter portion 570C of the port 570, the perimeter portion 557B of the port 557, the port 555, and the part infill 554 (i.e., material 2) are removed. A part is then formed using the part cavity correspond to the part infill 554.

### Example 7. Molding with Layered Ports

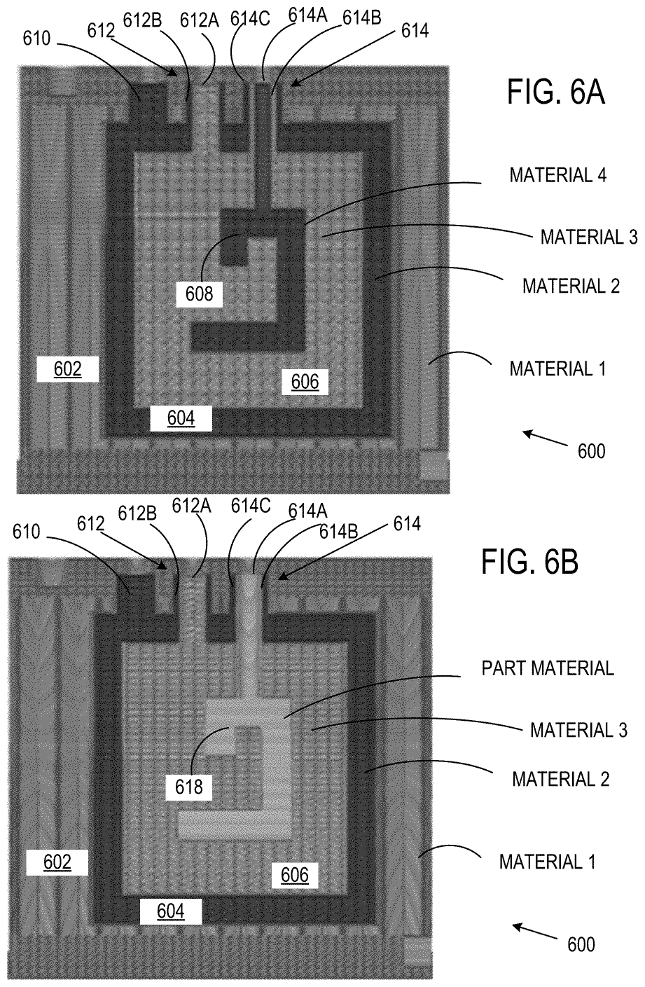

FIGS. 6A-6B are sectional views of a mold 600 that contains layered ports such as the ports 507, 510, 557, 570 illustrated in FIGS. 5A-5B. The mold 600 defines a mold infill 602 and part infills 604, 606, 608, each made of a respective material 1-4. In this example, materials 2-4 are sacrificial materials used to define part cavities and portions of ports used to access the parts cavities. The mold 600 includes ports 610, 612, 614, of which the ports 612, 614 are layered. The port 612 includes a central portion 612A and a perimeter portion 612B made of materials 3 and 2, respectively. The port 614 includes a central portion 614A, an intermediate portion 614B, and a perimeter portion 614C made of materials 4, 3, 2, respectively. In a first processing step, the infill in the central portion 614A of the port 614 and the part infill 608 (material 4) are removed to produce a part cavity and an access port to the part cavity. A part material is introduced and molded to form a first part 618 as shown in FIG. 6B. Typically some part material remains in the port 614 but can be removed. In a second step, the central portion 612A of the port 612, the intermediate portion 614B of the port 614, and the part infill 606 (material 3) are removed to provide access to and define a part cavity corresponding to the part infill 606. A part material is then introduced into this part cavity and molded by the part 618 and the part infill 604 to produce a second part. Some part material can remain in the in the central portion 612A of the port 612 and the intermediate portion 614B of the port 614, This process is repeated to remove material 2 from the port 610, the perimeter portion 612B of the port 612, the perimeter portion 614C of the port 614, and remove the infill 604 so that a third part can be formed using the second part and the mold infill 602. Material 1 and unwanted portions of the part material are then removed.

In multi-material examples such as illustrated in FIGS. 5A-6B, innermost parts are typically formed first and processing proceeds from the innermost parts to the outermost parts, but in some examples, other orderings are used. In addition, in some examples, ports that are not in use to open ports and to provide access for part molding can be used to fill or pressurize their respective infills to control temperatures or provide additional mold strength as parts are molded in other part cavities.

### Example 8. Molding with Part Surfaces

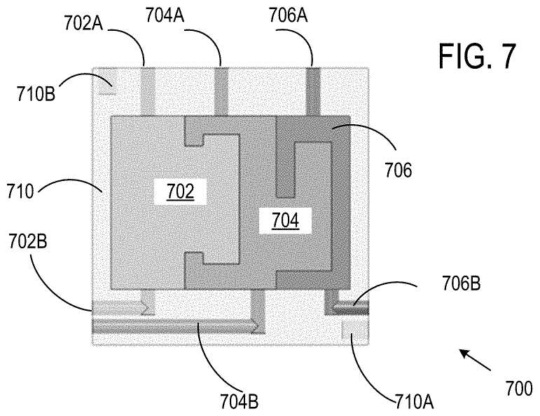

Referring to FIG. 7, a mold 700 includes parts cavities 702, 704, 706 situated in a mold volume 710. Materials used in part cavities 702, 704, 706 serve as mold materials and sacrificial materials. Infills are not shown in FIG. 7. Adjacent part cavities such as 702, 704 and 704, 706 typically use different sacrificial materials for infills so that the corresponding parts can be produced sequentially. In one example, the same material is used for infill in part cavities 702, 706 and the corresponding parts can be used in molding a part in the part cavity 704. In another example, parts are produced sequentially in each of the part cavities 702, 704, 706 so that formed parts are used to define mold surfaces. Ports 702A-702B, 704A-704B, and 706A-706B are used to access the part cavities 702, 704, 706, respectively, and ports 710A-710B are used to access the mold volume 710.

### Example 9. Additional Infills

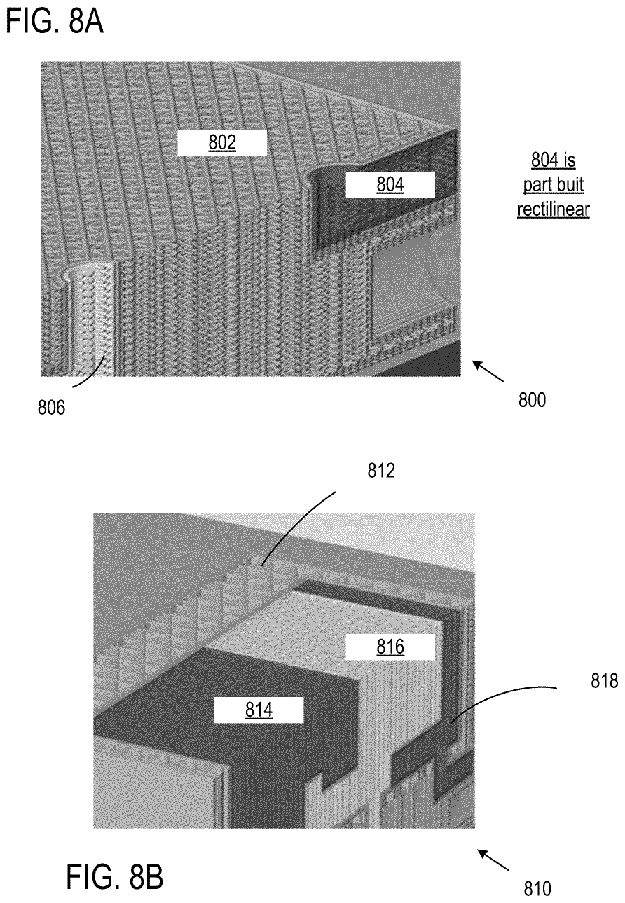

FIGS. 8A-8B illustrate additional infills. Referring to FIG. 8A, a mold 800 includes a mold infill 802, a port infill 806 and a port infill 804 formed of respective materials. The mold infill 802 is a ribbed infill above and below the port infill 804. Referring to FIG. 8B, a mold 810 includes a mold infill 812 and part infills 814. 816, 818. The mold infill 812 is a honeycomb, triangular, or other cellular infill around the part infills 814, 816, 818 while in other regions, the mold infill can be a ribbed infill.

In typical examples, a cellular infill surrounds part(s) from all directions. Ribbed infills are situated above and below the part(s), but generally do not contact the part(s).

### Example 10. Coolant Channels

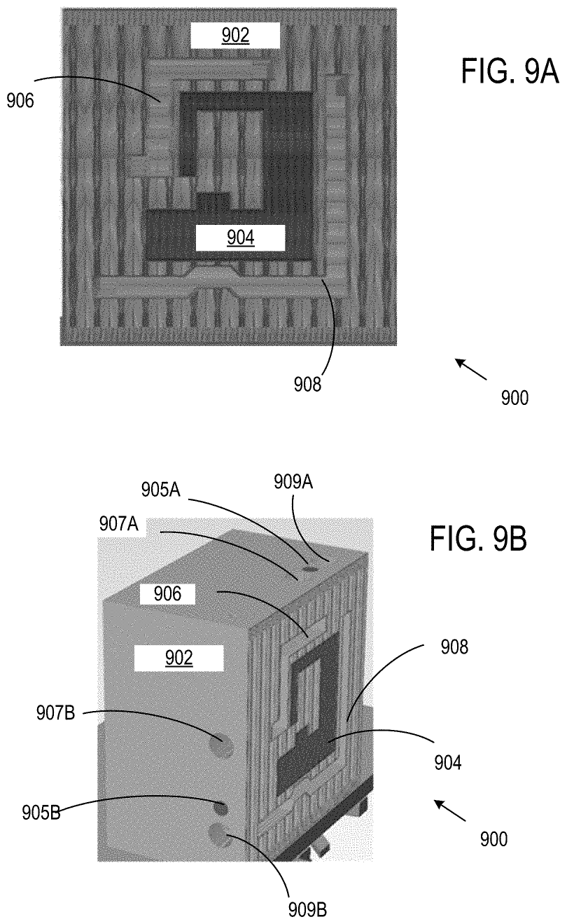

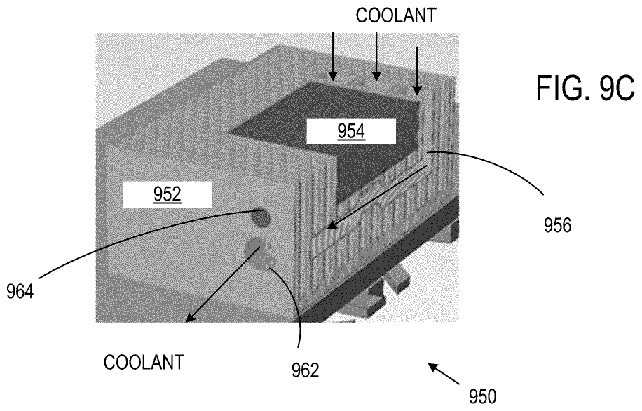

Referring to FIGS. 9A-9B, a mold 900 includes a mold infill 902 and a part infill 904. Channels 906, 908 are defined in the mold infill to permit introduction of a fluid coolant so that temperature profiles of part materials during curing or other processing can be controlled. FIG. 9B shows ports 907A, 907B and 909A, 909B that are coupled to channels 906, 908, respectively, and ports 905A, 905B that are coupled to part infill 906. Channels can be defined using additional infills or infills in use to define parts or molds.

In another example shown in FIG. 9C. a mold 950 includes a mold infill 952, a part infill 954, and a channel 956. The channel 956 is coupled to the mold infill 952 at a port 962. The part infill 954 is coupled to a port 964. Coolant flow is indicated. In the examples of FIGS. 9A-9C, molding walls used to define parts can be temperature controlled. Channels can be defined in the same manner as part and port cavities using suitable sacrificial materials. For example, layered tubes as described above can be used to define both part cavities and channels.

### Example 11. Thermal Shields and Temperature Reduction/Control

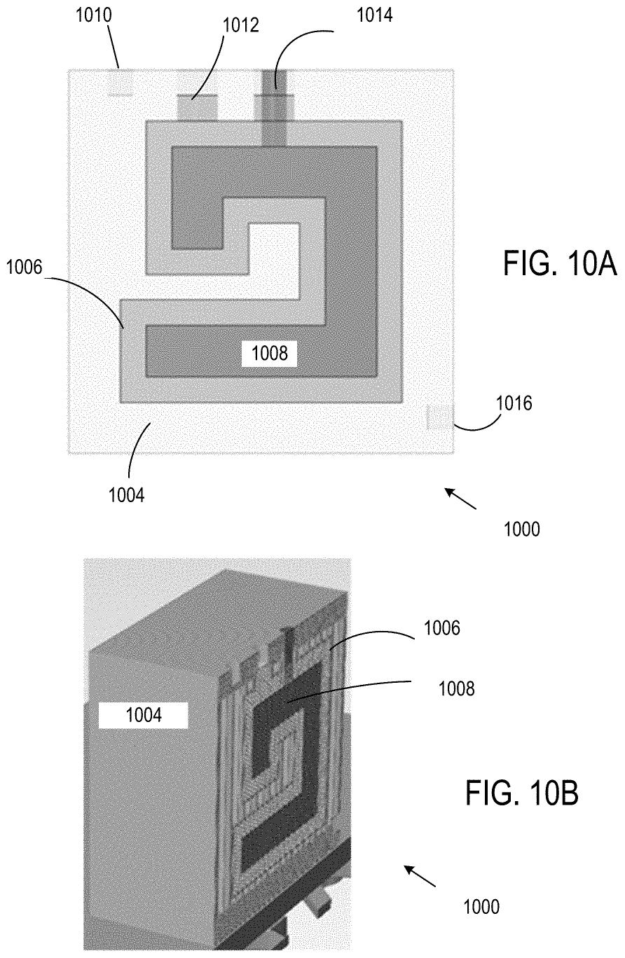

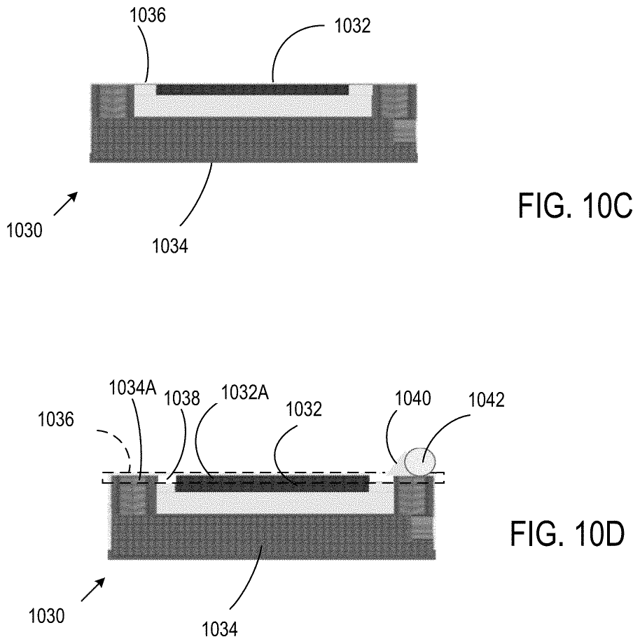

FIGS. 10A-10B illustrate a layered mold 1000 that includes mold infill 1004, a part infill 1008, a process infill 1006, and ports 1010, 1012, 1014, 1016. The process infill 1006 is used to define a cavity that can be filled with material suitable to reduce temperatures to which the mold infill 1004 is exposed so that part materials that require higher temperature processing can be molded.

Referring to FIG. 10C, a portion 1030 of a mold includes a part infill 1032, a mold infill 1034, and a temperature control barrier 1036. The temperature control barrier 1036 can be printed layer-by-layer, but as shown, is formed with a casting material that is added after adding new layers of part infill and mold infill. FIG. 10D shows the mold portion 1034 after addition (by printing) of one or more additional layers 1036 that include additional part infill 1032A and mold infill 1034A and define a cavity 1038 at the temperature control barrier 1036. A casting material 1040 is applied with, for example, a roller 1042, and the cavity 1038 is filled with the casting material 1040. Excess casting material can be removed, the casting material compacted or processed to be bound, and then additional layers of part and mold infill applied. In this way, a mold can be built-up and a temperature control wall can be formed using materials that need not be printable layer-by-layer. A temperature control wall can be used to permit use of higher process temperatures for part, sacrificial, or mold materials, or to control rates of heating and cooling.

### Example 12. Captive Parts with Coatings

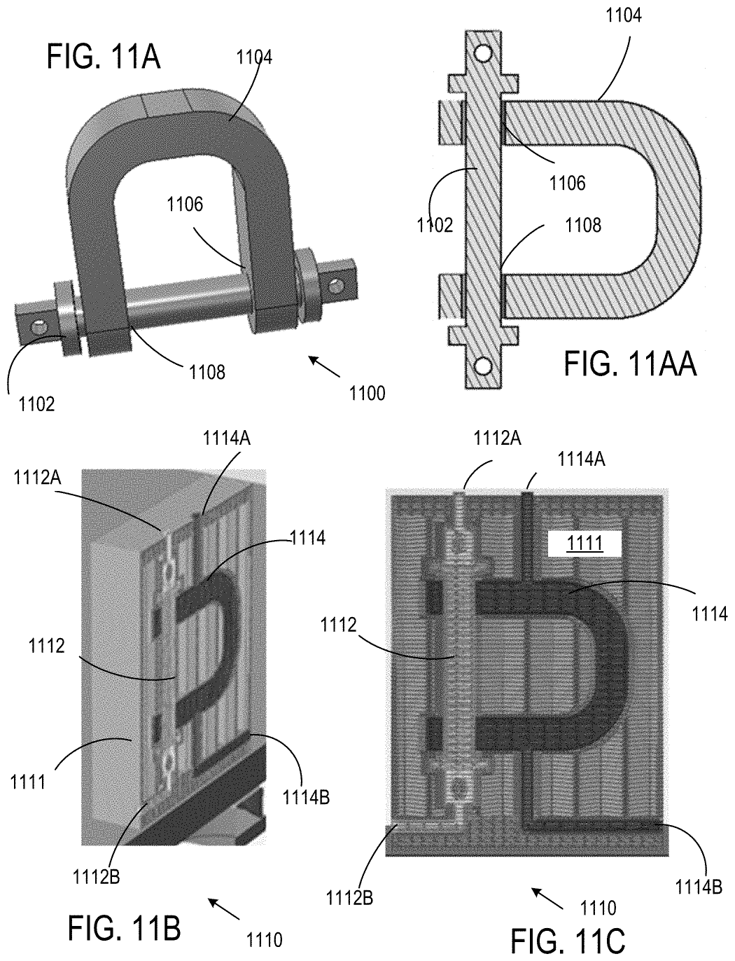

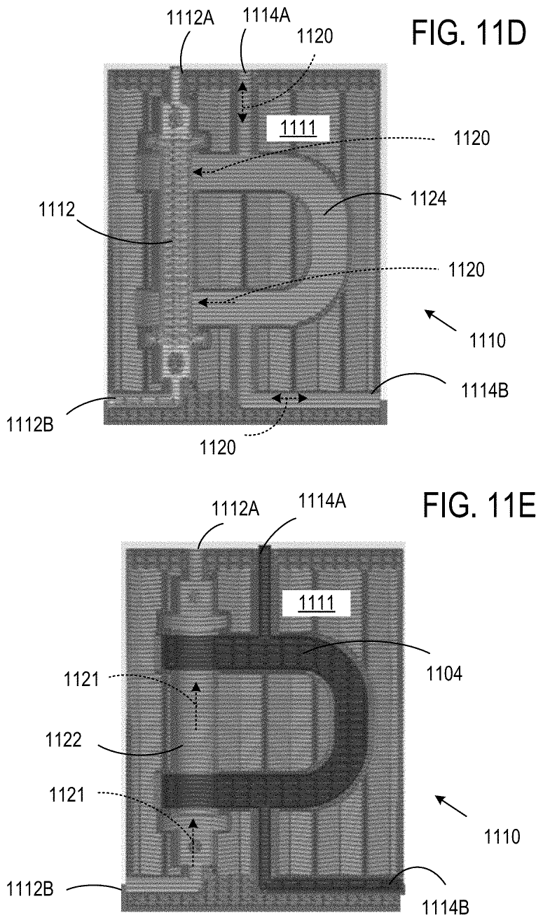

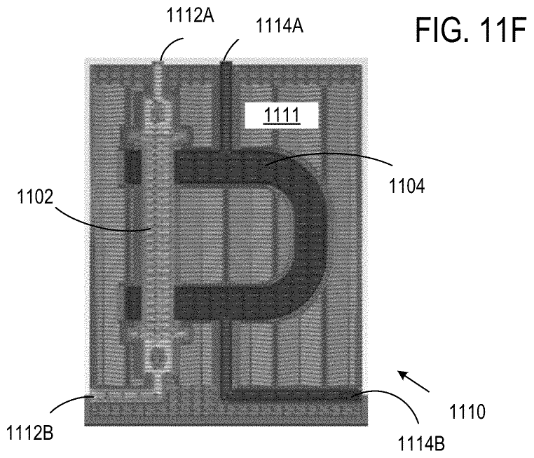

FIGS. 11A-11AA illustrate parts that are formed of a first part 1102 that is retained or captive in a second part 1104 and separated with gaps 1106, 1108 so that the first part 1102 is rotatable within the second part 1104. The first part 1102 can be referred to as a “captive part.” Such parts can be formed using additive molding as shown in FIGS. 11B-11F.

Referring to FIGS. 11B-11F, a mold 1110 includes infills 1112, 1114 defined in a mold infill 1111. The infills 1112, 1114 can be used to define cavities for the parts 1102, 1104, respectively, and are coupled to respective ports 1112A, 1112B and 1114A, 1114B. Mold ports are not shown. The mold 1110 can be used to define the parts 1102, 1104 as follows. First, as shown in FIG. 11D, the part infill 1114 is processed to define a cavity 1124 for the second part 1104 and a coating is then applied to interior surfaces of the cavity 1124 via the ports 1114A, 1114B which are opened as the part infill 1114 is removed and to surfaces of the part infill 1112 that are exposed by removal of the part infill 1114. Coating application is indicated with arrows 1120. The part infill 1114 is removed without removing the part infill 1112 and different infill (sacrificial) materials are used. Next, the part cavity 1124 is filled to produce the part 1104 as shown in FIG. 11E. Typically, the ports 1114A, 1114B are filled as well, but this fill material, if undesired, can be removed when molding is completed. FIG. 11E also illustrates removal of the part infill 1112 to define a part cavity 1122 for the first part 1102 and coating of the interior surfaces of the part cavity 1122 and portions of the second part 1104 that are to face the first part 1102. Coating application is indicated with arrows 1121. This coating may or may not be necessary if the coating shown in FIG. 11D has been previously applied. As shown in FIG. 11F, the first part 1102 is formed in the part cavity 1122 and is captive within the second part 1104. The mold material 1111 can be removed along with any part material in the ports 1112A, 1112B, 1114A, 1114B and any coatings.

### Example 13. Captive Parts with Molded Gaps

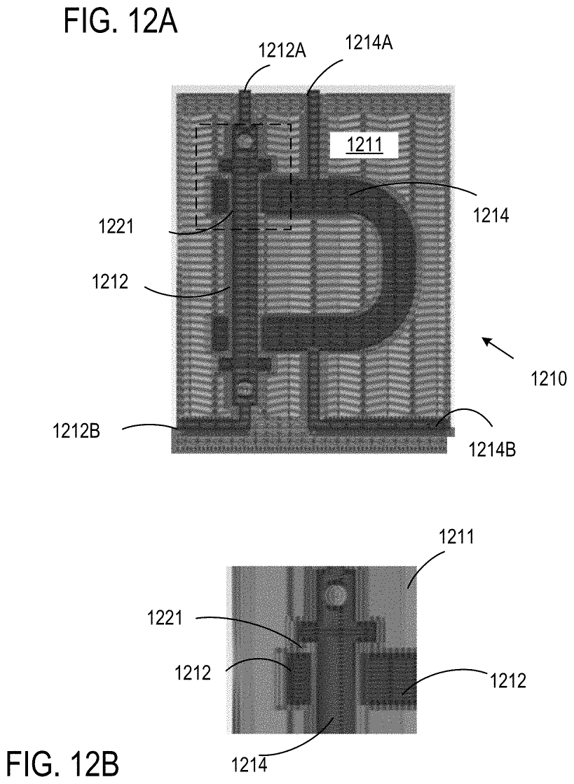

Another approach to molding the part 1100 uses a mold infill to define a gap between captive parts. Referring to FIGS. 12A-12B, a mold 1210 includes a mold infill 1211 and part infills 1212, 1214 which are separated by a spacer portion 1221 that is situated between the infills 1212, 1214. Using ports 1212A, 1212B, 1214A, 1214B, the infills 1212, 1214 are removed to form part cavities which are then filled with a part material to form corresponding parts. The mold infill 1211 is then removed, including the spacer portion 1221. The molded parts are processed to remove gates and port portions or otherwise adjusted to produce the part 1100. In this example, parts associated with part infills 1212, 1214 can be formed of a common material and processed in the same processing steps, but different materials can be used and materials can be processed in different processing steps.

### Example 14. Captive Parts with Sacrificial Gaps

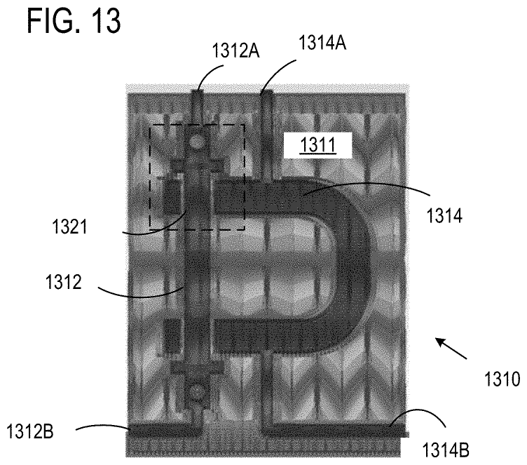

Additional sacrificial materials can be used to define gaps between captive parts for molding. Referring to FIG. 13, a mold 1310 includes a mold infill 1311 and part infills 1312, 1314 which are separated by a spacer sacrificial layer 1321 that is situated between the infills 1312, 1314. The sacrificial spacer can be made from a different material compared to the mold infill 1311 and the part infills 1312 and 1314. Using ports 1312A, 1312B, 1314A, 1314B, the infills 1312, 1314 are removed to form part cavities which are then filled with a part material to form corresponding parts. The mold infill 1311 is then removed as well as the spacer sacrificial layer 1321. The molded parts are processed to remove gates and port portions or otherwise adjusted to produce the part 1100. In this example, parts associated with part infills 1312, 1314 can be formed of a common material and processed in the same processing steps, but different materials can be used.

### Example 15. Representative Sacrificial Materials

Some representative materials are listed in the table below.

| Material | |
|---|---|
| (Sacrificial Part/Sacrificial Mold) | Dissolving Solvent |
| Polyvinyl Acetate (PVA) | Water |
| Butenediol Vinyl Alcohol | |
| Co-Polymer (BVOH) | |
| High Impact Polystyrene (HIPS) | D-limonene |
| Acrylonitrile Butadiene Styrene (ABS) | Acetone |
| Nylon | Hydrogen Peroxide |
| Wax | N/A (melts) |

### General Considerations

The disclosed methods and apparatus can be used in single or multi-material part processing, include processing of encapsulated parts, provision of variable thermal resistance and/or thermal reduction walls, processing with pour-in or casting walls for casting parts or thermal walls, and captive parts using gaps. The disclosed examples used two, three, or four materials, but more can be used. Typically three sacrificial materials permits complex parts made by filling a part cavity and solidifying the part material by curing, cooling, or other process. Parts and filled part cavities can be used to support molding of additional parts. Sacrificial materials that form an infill in a part cavity can be situated to serve as mold walls for other parts. Thermal resistance between parts can be selected based on material properties and mold wall thicknesses. Cavities can be filled at controlled temperatures, pressures, and fill rates. Thermal walls can be used to control temperatures to that materials that require higher temperature processing can be used with materials that can be otherwise unsuitable at higher temperatures. Mold materials and sacrificial materials are selected so that one material can be removed or molded without altering other materials in a mold remain unchanged. In the examples, each cavity is typically coupled to two ports, but fewer or more ports can be used. In view of the many possible embodiments to which the principles of the disclosure may be applied, it should be recognized that the illustrated embodiments are only examples and should not be taken as limiting the scope of the disclosure. I claim as my invention all that comes within the scope and spirit of the appended claims.

I claim:

1. A method, comprising:
selecting at least a mold material and a sacrificial material; and
with an additive process, defining, layer-by-layer:
at least a portion of a mold with the mold material, wherein the mold includes at least one mold ports, and
defining at least a portion of a part cavity with the sacrificial material.

2. The method of claim 1, further comprising defining at least one fill port with the sacrificial material, wherein the fill port is coupled to the part cavity.

3. The method of claim 2, wherein defining at least the portion of the mold with the mold material includes defining at least a portion of a part outline in the mold material or defining at the least the portion of the part cavity with the sacrificial material or both.

4. The method of claim 3, wherein the portion of the mold defined with the mold material includes a mold infill.

5. The method of claim 4, wherein the mold infill defined with the mold material includes one or more of a ribbed mold infill and a cellular mold infill.

6. The method of claim 4, wherein either the portion of the part cavity defined with the sacrificial material includes a part infill or portion of the sacrificial material defines a sacrificial material infill that is a cellular or ribbed infill.

7. The method of claim 6, wherein the fill ports contain the sacrificial material, and further comprising removing the sacrificial material from the part cavity and the fill ports.

8. The method of claim 6, further comprising, with the fill ports, removing the sacrificial material from the part cavity.

9. The method of claim 7, further comprising:
filling the part cavity with a part material;
processing the part material in the part cavity to produce the part; and
separating the part from the mold.

10. The method of claim 9, wherein the part is separated from the mold by one or more of injecting a solvent for the mold material into at least one of the mold ports, placing the mold into a liquid solvent, exposing the mold to a gas solvent, and placing the mold in a temperature chamber and melting the mold material.

11. The method of claim 1, wherein the selecting the sacrificial material includes selecting a first sacrificial material and a second sacrificial material, the first and second sacrificial materials being independently sacrificial; and
wherein defining at least the portion of the part cavity with the sacrificial material includes defining a first part cavity with the first sacrificial material and a second part cavity with the second sacrificial material, wherein the first part cavity and the second part cavity are adjacent so that the second part cavity is bounded in part by the first sacrificial material in the first part cavity.

12. The method of claim 11, further comprising defining at least one fill port coupled to the first part cavity with the first sacrificial material and at least one fill port coupled to the second part cavity with the second sacrificial material.

13. The method of claim 11, further comprising defining infill structures in at least one of the mold, the first part cavity, and the second part cavity with the mold material, the first sacrificial material, and the second sacrificial material, respectively.

14. The method of claim 13, further comprising, with the fill ports defined in the first sacrificial material:
removing the first sacrificial material from the first part cavity;
filling the first part cavity with a first part material; and
processing the first part material to produce a first part.

15. The method of claim 14, further comprising, with the fill ports defined in the second sacrificial material:
removing the second sacrificial material from the second part cavity;
filling the second part cavity with a second part material; and
processing the second part material to produce a second part.

16. The method of claim 15, further comprising removing the first part and the second part from the mold.

17. The method of claim 11, wherein the first part cavity is bounded by the second sacrificial material in the second part cavity and at least one fill port is coupled to the first part cavity and extends through the second part cavity.

18. The method of claim 1, wherein the selecting the sacrificial material includes selecting first, second, and third sacrificial materials, wherein at least the first and second sacrificial materials are independently sacrificial; and
wherein defining at least the portion of the part cavity with the sacrificial material includes defining a first part cavity with the first sacrificial material, a second part cavity with the second sacrificial material, and a third part cavity with the third sacrificial material, wherein the first part cavity is enclosed by the second part cavity, and the second part cavity is enclosed by the third part cavity, and the third part cavity is enclosed by the mold material, wherein the first and third sacrificial materials are the same or different.

19. The method of claim 18, further comprising defining fill ports coupled to the first, second, and third part cavities, wherein the respective fill ports extend through the second part cavity, the third part cavity, and the mold material.

20. The method of claim 19, further comprising sequentially removing the first, second, and third sacrificial materials and filling each of the first, second, and third parts cavities with respective part materials to form first, seconds, and third part.

21. A mold, comprising a plurality of layers, wherein one or more layers contains at least one mold material and at least one sacrificial material, the sacrificial material forming a part infill corresponding to a part cavity.

22. The mold of claim 21, further comprising at least one port coupled to the sacrificial material and defining a port infill formed with the sacrificial material.

23. The mold of claim 21, wherein the at least one sacrificial material includes first and second independent sacrificial materials, and the first and second independent sacrificial materials define respective part infills corresponding to respective part cavities.

24. The mold of claim 23, wherein the first part infill and the second part infill are in contact.

25. The mold of claim 23, wherein the first part infill is situated below the second part infill, and further comprising a port coupled to the first part infill through the second part infill and formed with the first sacrificial material.

26. The mold of claim 21, wherein the at least one sacrificial material includes first, second, and third independent sacrificial materials defining respective first, second, and third part infills corresponding to respective part cavities.

27. The mold of claim 26, further comprising a port coupled to the first part infill through the second part infill and the third part infill, the port comprising layers of the first, second, and third sacrificial materials.

28. The mold of claim 21, further comprising a thermal channel infill situated about the part infill.

29. The mold of claim 25, wherein the at least one sacrificial material forms part infills corresponding to a first part cavity and a second part cavity that define first and second parts, respectively, wherein the first part is a captive part with respect to the second part.

30. The mold of claim 29, further comprising an infill situated between the first part cavity and the second part cavity so that the first part is movably captured by the second part in the absence of the infill.

31. A method, comprising making a part using the mold of claim 21.

32. The method of claim 1, further comprising making a part using the mold.
